(19) United States
(12) Patent Application Publication
(10) Pub. No.: US 2025/0356757 A1
(43) Pub. Date: Nov. 20, 2025

(54) METHOD AND SYSTEM FOR AUTONOMOUS VEHICLE TO ACCEPT REMOTE HAND SIGNALS FROM VIRTUAL AUTHORITIES

(71) Applicant: International Business Machines Corporation, Armonk, NY (US)

(72) Inventors: Vinod A. Valecha, Pune (IN); Sarbajit Kumar Rakshit, Kolkata (IN); Saraswathi Sailaja Perumalla, Visakhapatnam (IN)

(21) Appl. No.: 18/665,738

(22) Filed: May 16, 2024

(51) Int. Cl. G08G 1/0967; B60W 60/00; G06F 3/01; G06V 40/20

(52) U.S. Cl. CPC G08G 1/096766; B60W 60/001; G08G 1/096708; B60W 2420/403; B60W 2420/408; B60W 2420/54; B60W 2556/45; B60W 2556/50; G06F 3/017; G06V 40/28

(57) ABSTRACT

An approach for allowing autonomous vehicles to follow traffic instructions from a virtual device is provided. The approach includes receiving instructions from virtual devices and identifying the instructions. The approach can further receive data from onboard sensors and determines a path based on the receive data and the instructions. Lastly, the approach can maneuver the vehicles based on the path.

### TECHNICAL FIELD

The present invention relates generally to autonomous vehicles, and more particularly to allowing autonomous vehicles to recognize and identify virtual traffic signals.

### BACKGROUND

Each city and states have rules and regulations regarding traffic. Traffic can include automotive and pedestrian-based traffic and other public-related happenings. Traffic flow analysis is generally analyzed based on compliance with rules, regulations, and ordinances designed to provide safety for motorists, pedestrians, and citizens. In instances in which law enforcement and/or emergency medical services (e.g., paramedics, physicians, etc.) are desired or required, the factor of time and the presence of the enforcement and/or medical service entities showing up at the location of an incident can dictate not only the results of a rule, regulation, or ordinance being violated, but more importantly damages sustained as a direct consequence of the violation.

In addition, due to the operation of autonomous vehicles, traffic flow may further be strained and may cause an increase in the presence of enforcement and/or emergency medical personnel. Thus, in some situations, law enforcement personnel may be deployed to direct and manage the traffic flow, which will include directing autonomous vehicles to deviate from its current route.

### SUMMARY

Aspects of the present invention disclose a computer-implemented method, a computer system and computer program product for allowing autonomous vehicles to follow traffic instructions from a virtual device. The computer implemented method may be implemented by one or more computer processors and may include: receiving instructions from virtual devices; identifying the instructions; receiving data from onboard sensors; determining a path based on the receive data and the instructions; and maneuvering the vehicles based on the path.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a functional block diagram illustrating a high-level overview of the AV environment, designated as 100, in accordance with an embodiment of the present invention;

FIG. 2 illustrates some commonly used traffic hand signals, in accordance with an embodiment of the present invention;

FIG. 3A is traffic lane intersection illustrating a normal flow of traffic for AV vehicles, designated as 300A, in accordance with an embodiment of the present invention;

FIG. 3B is traffic lane intersection illustrating a deviated flow of traffic for AV vehicles due to a vehicle accident at the intersection, designated as 300B, in accordance with an embodiment of the present invention;

FIG. 4 is a flowchart illustrating operational steps of AV component 111, designated as 400, in accordance with another embodiment of the present invention; and

FIG. 5 depicts a block diagram, designated as 500, of components of a server computer capable of executing the AV component 111 within the AV environment 100, in accordance with an embodiment of the present invention.

### DETAILED DESCRIPTION

Virtual Assistance deployment in augment reality environments, which includes deploying remote traffic police are discussed in U.S. patent application Ser. No. 18/184,020, the entirety of which is incorporated by reference herein.

In some traffic situation, such as an accident, where a law enforcement personnel is involved, some personnel may tend to the vehicle involved in the accident and some personnel may be in charge of diverting traffic away from the accident. Thus, in some situations, law enforcement personnel may be directing (via hand signals) autonomous vehicles to deviate from its current route. However, there are instances where virtual law enforcement personnel (via some virtual device) will be deployed at the accident scene instead of an actual human due to possible risks. For example, a chemical spilled from an overturn vehicle, a virtual law enforcement is deployed to help direct traffic away from the chemical spill.

Currently, autonomous vehicles are not able to recognize and identify traffic patterns and/or commands from a virtual law enforcement or other virtual personnel (e.g., medical services, etc.). Embodiments of the present invention recognize the above deficiencies and provides an approach,

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

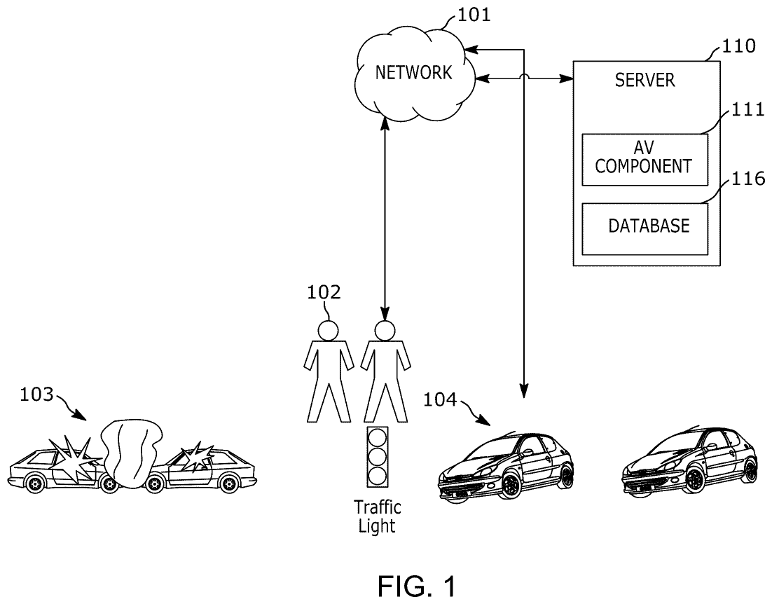

FIG. 1 is a functional block diagram illustrating an AV (Autonomous Vehicle) environment 100 in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

AV environment 100 includes network 101, virtual users 102, accident 103, vehicles 104 and server 110.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110, accident 103 and other computing devices (not shown) within AV environment 100. It is noted that other computing devices can include, but is not limited to, virtual users 102, vehicles 104 and any electromechanical devices capable of carrying out a series of computing instructions.

Virtual users 102 can be law enforcement personnel, traffic personnel, emergency medical service personnel that mirrors a remote user or can be AI powered. Virtual users 102, through a computerized hardware (i.e., virtual hardware/devices), which may contain a display screen, cameras, microphones and loudspeaker, allows the remote users or AI users to communicate traffic instructions to the public.

A use case scenario where a virtual users 102 is a law enforcement personnel, may rely on hand gesture based signal to communicate with different vehicles on the road. This can be achieved through the use of computer vision techniques to recognize hand gestures and map them to specific actions or messages that the virtual police want to communicate. The virtual police can use hand gestures to signal to drivers to slow down or stop in case of an accident or traffic congestion. They can also use hand gestures to direct traffic or indicate a change in traffic flow. For example, to implement this, the computing system can use cameras to capture the hand gestures of the virtual police and process the video feed in real-time. The video feed can be analyzed using computer vision algorithms to recognize the hand gestures and map them to specific actions or messages.

Accident 103 can be any traffic related event that causes a disruption to normal traffic flow. For example, two vehicles are involved in collision on a busy street. In another example, a vehicle suffers a malfunction and is stranded in the middle lane of a street.

Vehicles 104 can be autonomous vehicles without any human intervention. This can be fully autonomous vehicles, semi-autonomous vehicles (i.e., SAE, Society of Automotive Engineer level 3 or higher) or even non-autonomous vehicle.

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any other programmable electronic device capable of communicating other computing devices (not shown) within AV environment 100 via network 101. In another embodiment, server 110 represents a computing system utilizing clustered computers and components (e.g., database server computers, application server computers, etc.) that act as a single pool of seamless resources when accessed within AV environment 100.

Embodiment of the present invention can reside on server 110. Server 110 includes AV component 111 and database 116. However, embodiment can be deployed and reside on a cloud platform/infrastructure.

AV component 111, leveraging machine learning, first can validate the identity of the virtual personnel and for the virtual personnel to identify if the autonomous vehicle can accept hand or gesture-based signal. Secondly, AV component 111 can train autonomous vehicles to recognize and interpret hand-based or gesture-based commands.

Database 116 is a repository for data used by AV component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within AV environment 100, provided that AV component 111 has access to database 116. Database 116 may store information associated with, but is not limited to, knowledge corpus, i) traffic gestures of police personnel from around the world, ii) video data of hand gestures performed by various authorized personnel, iii) still data of video data of hand gestures performed by various authorized personnel, iv) communication protocols of virtual devices, v) machine learning models for autonomous vehicle to calculate a new path and vi) communication protocols from onboard sensors.

As is further described herein below, AV component 111 of the present invention provides the capability of, i) training an AV traffic recognition model to recognize hand gesture as traffic instructions and ii) allowing autonomous vehicles to safely execute maneuvers base d on the new traffic instructions.

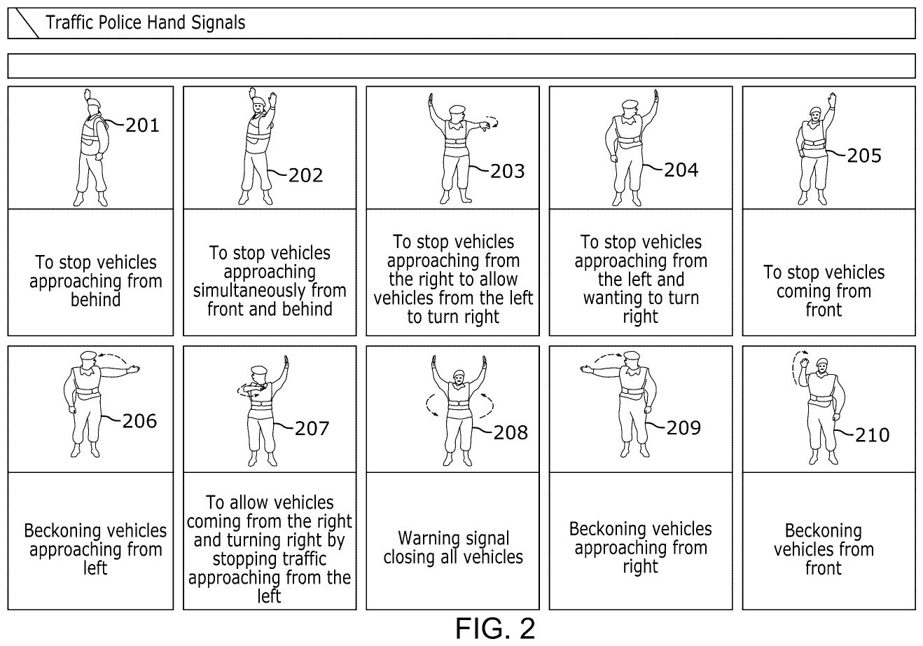

FIG. 2 illustrates some commonly used traffic hand signals, in accordance with an embodiment of the present invention. For example, 201 denotes a signal for stop vehicles from approaching from behind. Other traffic gestures (e.g., 202, 203, 204, 205, 206, 207, 208, 209, 210) denotes various instructions (see FIG. 2.).

### Training an AV (Autonomous Vehicle) Model

This process involves using the digital identity of the virtual users to identify if the autonomous vehicle can accept hand or gesture-based signals. This can be achieved through a combination of computer vision (e.g., object recognition via video, etc.) and machine learning techniques.

An example of a high-level process will be outlined below, which someone skilled in the art, can understand and duplicate:

The first step is to train a machine learning model to recognize hand or gesture-based signals. This can be done using a large dataset of images or videos of people performing different hand gestures or signals (see some samples of hand gesture from FIG. 2). The machine learning model can be trained using techniques such as deep learning, which involves training neural networks on large amounts of data. It is noted that FIG. 2 is not exhaustive and may differ across each country and jurisdiction.

Once the machine learning model is trained, then a test/validation phase can occur. This involves analyzing the video stream and identifying areas of the image that correspond to hands or gestures. It is noted that not all instructions provided from virtual users may involve video/pictures and/audio. Any validation and/or testing techniques that involves training machine learning models may be utilized. It is possible that traffic instructions can also be broadcast (concurrently with the visual signals) through various radio frequencies hardware, included on the virtual device (e.g., WIFI, Bluetooth, etc.).

The embodiment can then use the digital identity of the virtual users (i.e., making sure virtual police personnel is authorized to use virtual devices) and to identify if the autonomous vehicle is capable of accepting hand or gesture-based signals. This can be done by cross-referencing the digital identity with a database of known autonomous vehicle models and their capabilities.

If the embodiment determines that the autonomous vehicle is capable of accepting hand or gesture-based signals, it can then relay the signal from the virtual device to the vehicle. This can be done through a variety of communication channels, such as wireless or cellular networks (on the virtual device), depending on the specific implementation of the system.

### Execute Maneuver Based on Signals

This process involves identifying the hand or gesture-based signals and corresponding vehicle movement associated with the signal. For example, a virtual user holding out his hand with a palm facing a vehicle would typically indicate that the vehicle should come to a complete stop.

This can be achieved through a combination of computer vision (e.g., object recognition via video, etc.) and machine learning techniques.

An example of a high-level process will be outlined below, which someone skilled in the art, can understand and duplicate:

This process can be achieved by collecting a large dataset of hand-based commands and their corresponding meanings. The dataset can be used to train a machine learning model such as a convolutional neural network (CNN) or a recurrent neural network (RNN) to recognize the hand-based commands and associate them with the appropriate action to be taken by the autonomous vehicle.

For example, if the virtual users indicate a hand signal to a vehicle to stop, the machine learning model will be trained to recognize the specific hand gesture associated with the stop signal and instruct the vehicle to come to a stop. Similarly, if the virtual users indicate a signal to a vehicle to slow down or change lanes, the machine learning model will be trained to recognize the corresponding hand gestures and instruct the vehicle to take the appropriate action.

Once the machine learning model has been trained, it can be integrated into the autonomous vehicle's software system, allowing the vehicle to receive and interpret hand-based signals from the virtual police and respond accordingly.

The vehicle's autonomous driving system will take into account various factors such as the road condition, traffic density, and other surrounding vehicles before making any driving decisions. For instance, if the virtual police signal the vehicle to turn left, the vehicle's autonomous driving system will first check if there is any oncoming traffic, and if it is safe to make the turn.

Once the vehicle's autonomous driving system has determined the appropriate driving decision, it will act accordingly. For instance, if the virtual police signal the vehicle to stop, the vehicle's autonomous driving system will immediately apply the brakes and bring the vehicle to a halt.

The system will continuously monitor the road situation and make any necessary adjustments to the driving behavior of the autonomous vehicles. This will ensure that the vehicles are driving safely and following all traffic rules and regulations.

### OTHER EMBODIMENTS

In other embodiments, the virtual users (i.e., police), being an avatar in the VR environment, will be assigned a unique identity that can be communicated to autonomous vehicles in the surrounding area. This identity can be used by the vehicles to identify and communicate with the virtual users, if necessary. For example, if an autonomous vehicle detects an obstacle on the road and cannot navigate around it, it can send a request to the virtual police for assistance. The request will be sent to the virtual police identity, and the virtual police can respond by providing guidance or taking necessary action to remove the obstacle.

This identity can also be used by the virtual users (i.e., police) to communicate with the human users (i.e., police), who are physically present in the area, and inform them of the situation. This can help in coordinating the response and ensuring that the necessary actions are taken promptly.

In another embodiment, virtual users can be integrated as part of visual display in the vehicle. For example, if the virtual police signal the vehicle to slow down, the onboard computer will receive the signal and reduce the speed of the vehicle. Similarly, if the virtual police signal the vehicle to change lanes, the onboard computer will identify the command and initiate the lane change.

In another example, participating vehicles can also visualize the virtual police on the road using the VR system. This will help the drivers to understand the situation better and respond accordingly to the hand-based signals. In addition, the virtual police can also use their avatars to provide visual cues to the participating vehicles. For example, if the virtual police avatar points to a specific direction, the vehicles can interpret it as a signal to change lanes in that direction.

Embodiment with Non-Autonomous Vehicle

In another embodiment, the present invention can be implemented in non-autonomous vehicle with a slight variation. For example, a vehicle equipped with a vision/camera system to help detect road hazards can be utilized to help a distracted human driver be aware of a traffic event requiring attention to virtual and/or live personnel to redirect traffic. The distracted human driver can be notified by their vehicle through the vehicle's sound system and/or on-screen display. The human driver would have to apply the necessary control (e.g., brake, turn, etc.) based on the received notification.

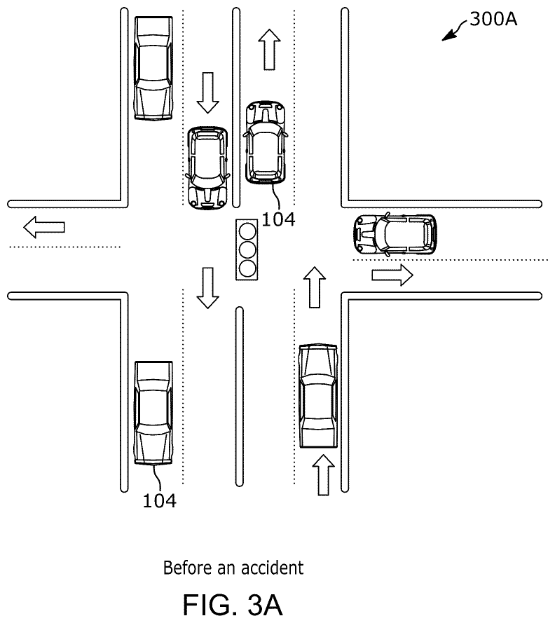

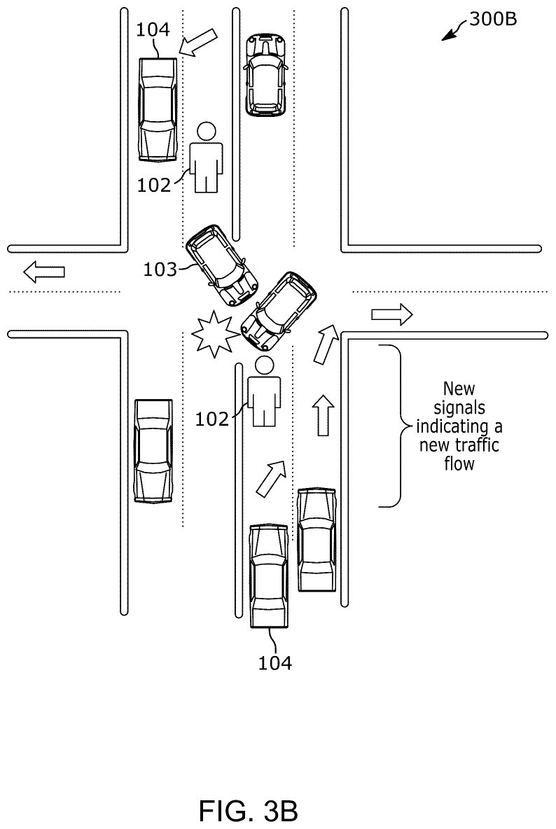

FIG. 3A is traffic lane intersection illustrating a normal flow of traffic for AV vehicles, designated as 300A, in accordance with an embodiment of the present invention. As shown, AV vehicles are proceeding (see the indicated arrows) through the traffic intersection as normal. However, FIG. 3B illustrates a deviated flow of traffic for AV vehicles due to a vehicle accident at the intersection, designated as 300B, in accordance with an embodiment of the present invention.

Virtual users 102 (i.e., police personnel) are deployed at the accident and are directing vehicles (e.g., autonomous and non-autonomous vehicles) to proceed a new path (see the new arrows) to avoid the accident.

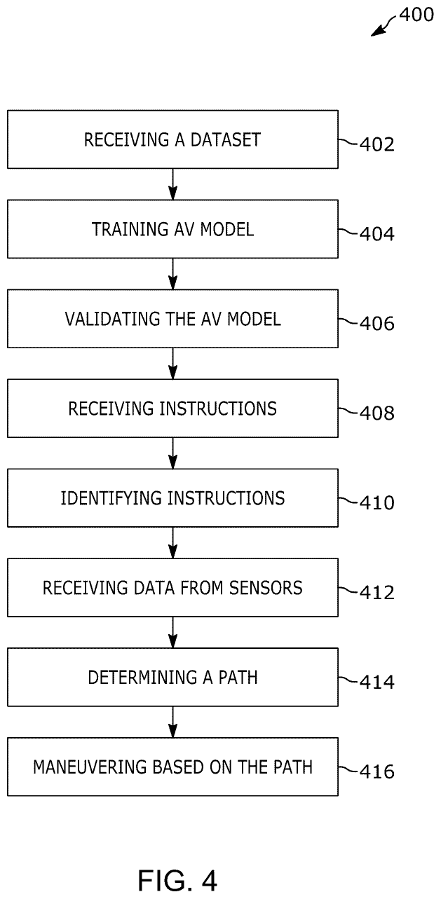

FIG. 4 is a flowchart illustrating one operation of AV component 111, designated as 400, in accordance with one embodiment of the present invention. This flowchart is the second major process after the first major process relating to training. Recall that the overall process relating to training includes, consuming a large dataset of images or videos of people performing different hand gestures or signals. The machine learning model can be trained using techniques such as deep learning, which involves training neural networks on large amounts of data. Furthermore, once the machine learning model is trained, embodiment can use computer vision techniques to detect the presence of a hand or gesture-based signal in the video stream from the cameras. This involves analyzing the video stream and identifying areas of the image that correspond to hands or gestures.

AV component 111 receives dataset of images and/or videos (step 402) to train one or more AV recognition models. Furthermore, AV component 111 trains the one or more AV recognition models (step 404) based on the received dataset. For example, machine learning model(s) can be trained using techniques such as deep learning, which involves training neural networks on large amounts of data. Lastly, AV component 111 validates the one or more AV recognition model(s) against live data (step 406). For example, once the machine learning model is trained, the system can use computer vision techniques to detect the presence of a hand or gesture-based signal in the video stream from the cameras. This involves analyzing the video stream and identifying areas of the image that correspond to hands or gestures.

In the next process, a user case scenario will be used to illustrate. The use case will involve a traffic accident, two vehicles collided in the middle of a busy intersection, (see FIGS. 3A and 3B) and virtual police (see 102 from FIG. 3B) are deployed on the scene to redirect traffic. There are vehicles, including autonomous vehicles (see 104 of FIG. 3B). That must navigate around the accident.

AV component 111 receives signals from virtual users (step 408). Embodiment may receive traffic related instructions from virtual users (via VR device) to deviate from an initial path. For example, virtual police instruct (hand signals) the vehicles to avoid the middle lane of a two-lane road and to merge to the far-right lane. The hand signal may include a combination of a stop signal (see FIG. 2 for some examples of hand signals) and beckon traffic signal.

AV component 111 identifies the instructions based on the received signal (step 410). Embodiment, through machine learning and/or other learning techniques, will determine what traffic/vehicle instructions are given based on the received signal. For example, from the previous step, the virtual police use a palm away gesture with a left hand and then followed by a finger pointing instruct (hand signals) the vehicles. AV component 111, identifies the corresponding traffic instructions to the hand signals. In some embodiments, AV component 111 may leverage database 116 to search through a corpus knowledge of hand signals, etc.

AV component 111 receives data from onboard sensors (step 412). After identifying what traffic instructions to perform, AV component 111 receives data from onboard sensors (e.g., radar, sonar, camera, microphone, GPS, etc.) of the vehicle.

AV component 111 determines a path based on the receive data and the instructions (step 414). Based on the received data (from onboard sensors), AV component 111 can calculate a new vehicle path based on the identified instructions (from step 410) and received data (from step 412). The calculation can be performed on board via the CPU (central processing unit) of the vehicle and/or performed on the cloud.

AV component 111 maneuvers the autonomous vehicle based on the calculated (new) path (step 416). AV vehicle determined that it is safe to proceed to a new path (as instructed by virtual users). For example, the new path is to avoid the left lane of a two-lane road and make right turn at the intersection (see FIG. 3B).

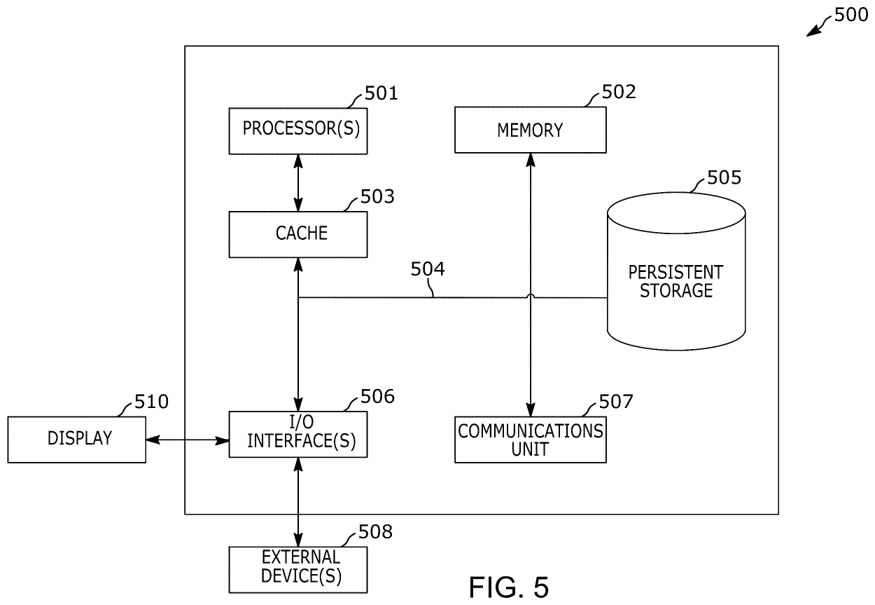

FIG. 5, designated as 500, depicts a block diagram of components of AV component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 5 includes processor(s) 501, cache 503, memory 502, persistent storage 505, communications unit 507, input/output (I/O) interface(s) 506, and communications fabric 504. Communications fabric 504 provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of processor(s) 501 by holding recently accessed data, and data near recently accessed data, from memory 502.

Program instructions and data (e.g., software and data x10) used to practice embodiments of the present invention may be stored in persistent storage 505 and in memory 502 for execution by one or more of the respective processor(s) 501 via cache 503. In an embodiment, persistent storage 505 includes a magnetic hard disk drive. Alternatively, or in addition to a magnetic hard disk drive, persistent storage 505 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505. AV component 111 can be stored in persistent storage 505 for access and/or execution by one or more of the respective processor(s) 501 via cache 503.

Communications unit 507, in these examples, provides for communications with other data processing systems or devices. In these examples, communications unit 507 includes one or more network interface cards. Communications unit 507 may provide communications through the use of either or both physical and wireless communications links. Program instructions and data (e.g., AV component 111) used to practice embodiments of the present invention may be downloaded to persistent storage 505 through communications unit 507.

I/O interface(s) 506 allows for input and output of data with other devices that may be connected to each computer system. For example, I/O interface(s) 506 may provide a connection to external device(s) 508, such as a keyboard, a keypad, a touch screen, and/or some other suitable input device. External device(s) 508 can also include portable computer readable storage media, such as, for example, thumb drives, portable optical or magnetic disks, and memory cards. Program instructions and data (e.g., AV component 111) used to practice embodiments of the present invention can be stored on such portable computer readable storage media and can be loaded onto persistent storage 505 via I/O interface(s) 506. I/O interface(s) 506 also connect to display 510.

Display 510 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A computer-implemented method for allowing vehicles to follow traffic instructions from a virtual device, the computer-method comprising:
receiving instructions from virtual devices;
identifying the instructions;
receiving data from onboard sensors;
determining a path based on the receive data and the instructions; and
maneuvering the vehicles based on the path.

2. The computer-implemented method of claim 1, comprising:
receiving a large dataset;
training one or more AV models based on the large dataset;
testing one or more models; and
deploying one or more models.

3. The computer-implemented method of claim 1, wherein the virtual devices are remotely controlled by virtual users and the instructions are displayed on the virtual devices as a series of hand gestures.

4. The computer-implemented method of claim 1, wherein the instructions consist of traffic instructions.

5. The computer-implemented method of claim 1, wherein onboard sensors comprises of radar, sonar, camera, microphone and GPS.

6. The computer-implemented method of claim 1, wherein the vehicles includes non-autonomous vehicles and autonomous vehicles.

7. The computer-implemented method of claim 3, wherein identifying the instructions comprises:
identifying the hand gestures based on the one or more AV models; and
determining traffic instructions based on the identified hand gestures.

8. A computer program product for allowing autonomous vehicles to follow traffic instructions from a virtual device, the computer program product comprising:
one or more computer readable storage media and program instructions stored on the one or more computer readable storage media, the program instructions comprising the steps of:
receiving instructions from virtual devices;
identifying the instructions;
receiving data from onboard sensors;
determining a path based on the receive data and the instructions; and
maneuvering the vehicles based on the path.

9. The computer program product of claim 8, comprising:
receiving a large dataset;
training one or more AV models based on the large dataset;
testing one or more models; and
deploying one or more models.

10. The computer program product of claim 8, wherein the virtual devices are remotely controlled by virtual users and the instructions are displayed on the virtual devices as a series of hand gestures.

11. The computer program product of claim 8, wherein the instructions consist of traffic instructions.

12. The computer program product of claim 8, wherein onboard sensors comprises of radar, sonar, camera, microphone and GPS.

13. The computer program product of claim 8, wherein the vehicles includes non-autonomous vehicles and autonomous vehicles.

14. The computer program product of claim 8, wherein identifying the instructions comprises:
identifying the hand gestures based on the one or more AV models; and
determining traffic instructions based on the identified hand gestures.

15. A computer system for allowing autonomous vehicles to follow traffic instructions from a virtual device, the computer system comprising:
one or more computer processors;
one or more computer readable storage media;
program instructions stored on the one or more computer readable storage media for execution by at least one of the one or more computer processors, the program instructions comprising the steps of:
receiving instructions from virtual devices;
identifying the instructions;
receiving data from onboard sensors;
determining a path based on the receive data and the instructions; and
maneuvering the vehicles based on the path.

16. The computer system of claim 15, comprising:
receiving a large dataset;
training one or more AV models based on the large dataset;
testing one or more models; and
deploying one or more models.

17. The computer system of claim 15, wherein the virtual devices are remotely controlled by virtual users and the instructions are displayed on the virtual devices as a series of hand gestures.

18. The computer system of claim 15, wherein the instructions consist of traffic instructions.

19. The computer system of claim 15, wherein onboard sensors comprises of radar, sonar, camera, microphone and GPS.

20. The computer system of claim 15, wherein identifying the instructions comprises:
identifying the hand gestures based on the one or more AV models; and
determining traffic instructions based on the identified hand gestures.
